(19) United States
(12) Patent Application Publication
(10) Pub. No.: US 2022/0301514 A1
(43) Pub. Date: Sep. 22, 2022

(54) DISPLAY EQUIPMENT AND DISPLAY DEVICE

(71) Applicant: TCL CHINA STAR OPTOELECTRONICS TECHNOLOGY CO., LTD., Shenzhen, Guangdong (CN)

(72) Inventor: Bo XIAO, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/053,536

(22) PCT Filed: Aug. 6, 2020
(86) PCT No.: PCT/CN2020/107319

§ 371 Date: Nov. 6, 2020

(30) Foreign Application Priority Data
Jul. 9, 2020 (CN) 202010654678.7

(51) Int. Cl. G09G 3/36; G01K 7/24

(52) U.S. Cl. CPC G09G 3/3696; G01K 7/24; G09G 2320/041; G09G 2310/08; G09G 2330/025; G09G 2300/0408

(57) ABSTRACT

A display equipment and a display device are provided. An electrical potential shifting module is provided with a default current value corresponding to an electrical signal, which improves accuracy of an overcurrent judgment. When a real-time current value is greater than or equal to the default current value, the electrical potential shifting module stops outputting, thereby preventing a display panel from being damaged by an overcurrent or reducing damage by the overcurrent.

### FIELD OF INVENTION

The present disclosure relates to the field of overcurrent protection technologies, and more particularly, to a display equipment and a display device.

### BACKGROUND OF INVENTION

Overcurrent protection is widely used in electronic products to prevent the electronic products from being damaged by an overcurrent or to reduce damage by the overcurrent. Display products are more expensive electronic products, so providing an overcurrent protection function for the display products can extend a service life of the display products.

As we all know, overcurrent is often accompanied by changes in temperature, and as the temperature changes, occurrence/judgment conditions of the overcurrent also change. However, in conventional technical solutions, overcurrent threshold values of the display products are usually a fixed temperature value or a fixed temperature range, which seriously reduces accuracy of an overcurrent judgment, thereby increasing a probability of the display products being damaged by overcurrent.

Technical problem: the present disclosure provides a display equipment to solve problems of lower accuracy of judging an overcurrent, which results in an increased probability of damage by the overcurrent.

### SUMMARY OF INVENTION

In a first aspect, the present disclosure provides a display equipment which includes a temperature detection module, a current detection module, and an electrical potential shifting module. The temperature detection module is configured to detect a temperature of a display panel and to output an electrical signal corresponding to the temperature; the current detection module is configured to detect a real-time current value of the display panel; and the electrical potential shifting module is connected to the temperature detection module, the current detection module, and the display panel, and is configured to receive the electrical signal and the real-time current value and to correspondingly output an electrical potential signal to the display panel according to a comparison result between the real-time current value and a default current value; wherein the electrical potential shifting module is provided with the default current value corresponding to the electrical signal, and when the real-time current value is greater than or equal to the default current value, the electrical potential shifting module stops outputting.

Based on the first aspect, in a first embodiment of the first aspect, the display panel is a liquid crystal display panel provided with a gate driver on array (GOA) circuit, the temperature detection module is configured to detect a temperature in an area related to the GOA circuit, and the current detection module is configured to detect a real-time current value of the GOA circuit.

Based on the first aspect, in a second embodiment of the first aspect, the electrical potential shifting module obtains the electrical signal at a fixed time interval to renew the default current value corresponding to the electrical signal.

Based on the first aspect, in a third embodiment of the first aspect, the temperature detection module comprises a voltage divider resistor and a thermistor configured to detect the temperature of the display panel, a first voltage signal is connected to a first end of the thermistor, a second end of the thermistor is connected to a first end of the voltage divider resistor, a connected node of the thermistor and the voltage divider resistor outputs the electrical signal, and a second end of the voltage divider resistor is connected to a second voltage signal, wherein an electrical potential of the first voltage signal is greater than an electrical potential of the second voltage signal.

Based on the first aspect, in a fourth embodiment of the first aspect, the display equipment further includes a power management module connected to at least the electrical potential shifting module to power the electrical potential shifting module.

Based on the fourth embodiment of the first aspect, in a fifth embodiment of the first aspect, the electrical potential shifting module comprises a control unit, a storage unit, and an output unit; the power management module is connected to at least the control unit, and the control unit is connected to the temperature detection module, the current detection module, the storage unit, and the output unit; and the control unit calls the default current value in the storage unit corresponding to the electrical signal to compare with the real-time current value, when the real-time current value is greater than or equal to the default current value, the control unit outputs a control signal to the power management module, and the power management module stops powering the electrical potential shifting module according to the control signal.

Based on the third embodiment of the first aspect, in a sixth embodiment of the first aspect, the thermistor is a thermistor with a negative temperature coefficient.

Based on any one of the above embodiments of the first aspect, in a seventh embodiment of the first aspect, the electrical signal is a voltage signal.

Based on the seventh embodiment of the first aspect, in an eighth embodiment of the first aspect, the electrical potential shifting module stores a plurality of groups of default current values each corresponding to an electrical potential of the electrical signal.

Based on the seventh embodiment of the first aspect, in a ninth embodiment of the first aspect, the temperature has a positive correlation with an electrical potential of the electrical signal.

Based on the seventh embodiment of the first aspect, in a tenth embodiment of the first aspect, an electrical potential of the electrical signal has a negative correlation with the default current value.

In a second aspect, the present disclosure provides a display device which includes any one of the display equipments in the above embodiments.

Based on the second aspect, in a first embodiment of the second aspect, the display device further includes a timing controller connected to at least the electrical potential shifting module.

Beneficial effect: in the display equipment and the display device provided by the present disclosure, the electrical potential shifting module is provided with a default current value corresponding to an electrical signal, which improves accuracy of an overcurrent judgment. When a real-time current value is greater than or equal to the default current value, the electrical potential shifting module stops outputting, thereby preventing the display panel from being damaged by an overcurrent or reducing the damage by the overcurrent.

### DESCRIPTION OF DRAWINGS

FIG. 1 is a first schematic structural diagram of a display equipment according to an embodiment of the present disclosure.

FIG. 2 is a second schematic structural diagram of the display equipment according to an embodiment of the present disclosure.

FIG. 3 is a third schematic structural diagram of the display equipment according to an embodiment of the present disclosure.

FIG. 4 is a fourth schematic structural diagram of the display equipment according to an embodiment of the present disclosure.

FIG. 5 is a schematic structural diagram of a display device according to an embodiment of the present disclosure.

FIG. 6 is a schematic diagram of a correspondence relationship between an electrical signal and a temperature according to an embodiment of the present disclosure.

FIG. 7 is a schematic diagram of a correspondence relationship between a default current value and the temperature according to an embodiment of the present disclosure.

FIG. 8 is a schematic diagram of a correspondence relationship between the electrical signal and the default current value according to an embodiment of the present disclosure.

### DETAILED DESCRIPTION OF PREFERRED EMBODIMENTS

In order to make the purpose, technical solutions, and effects of the present disclosure clearer and more definite, the following further describes the present disclosure in detail with reference to the drawings and embodiments. It should be understood that the specific embodiments described herein are only used to explain the disclosure, and are not used to limit the disclosure.

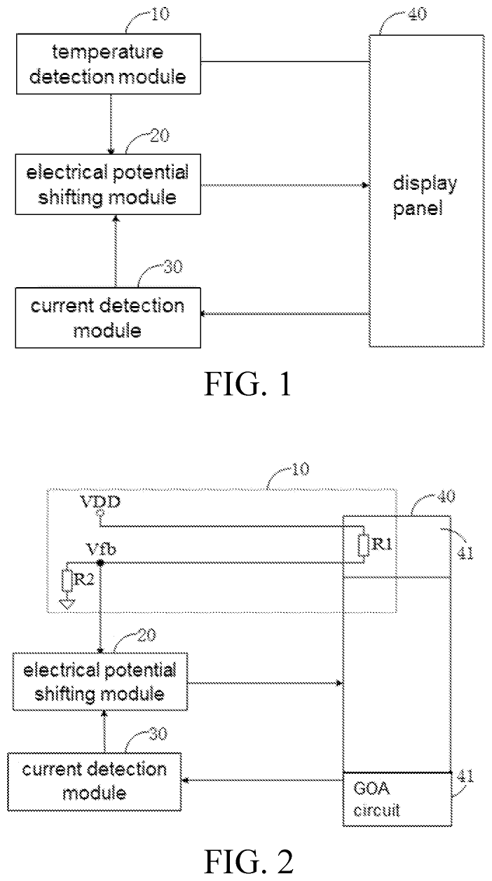

As shown in FIG. 1, an embodiment of the present disclosure provides a display equipment. The display equipment includes a temperature detection module 10, a current detection module 30, and an electrical potential shifting module 20. The temperature detection module 10 is configured to detect a temperature of a display panel 40 and to output an electrical signal corresponding to the temperature. The current detection module 30 is configured to detect a real-time current value of the display panel 40. The electrical potential shifting module 20 is connected to the temperature detection module 10, the current detection module 30, and the display panel 40, and is configured to receive the electrical signal and the real-time current value and to correspondingly output an electrical potential signal to the display panel 40 according to a comparison result between the real-time current value and a default current value. Wherein, the electrical potential shifting module 20 is provided with the default current value corresponding to the electrical signal, and when the real-time current value is greater than or equal to the default current value, the electrical potential shifting module 20 stops outputting.

It can be understood that when the real-time current value is less than or equal to the default current value, the electrical potential shifting module 20 can work normally to output normally.

It should be noted that in this embodiment, a plurality of groups of default current values corresponding to the electrical signal can be set according to properties of the electrical signal to further improve accuracy of judging an occurrence of an overcurrent. Wherein, the properties of the electrical signal may be, but is not limited to, an electrical potential Vfb of the electrical signal or a current value of the electrical signal, which has a corresponding relationship with the temperature to more accurately judge an overcurrent threshold value which continuously changes with changing of the temperature when an overcurrent occurs.

It can be understood that the overcurrent in the present disclosure is consistent with an excess current.

When the display equipment provided by the present disclosure is used in the field of the display panel 40, it can protect glass components in the display panel 40 with greatest accuracy when an overcurrent occurs. For example, materials, such as glass substrates, damaged by the overcurrent can be prevented or reduced, maintenance cost when the overcurrent occurs can be reduced, and a service life of the display panel 40 can be extended.

It can be noted that the electrical potential shifting module 20 may output, but is not limited to, a corresponding high electrical potential signal and/or low electrical potential signal to the display panel 40. When an overcurrent is detected, the electrical potential shifting module 20 stops providing the corresponding high electrical potential signal and/or low electrical potential signal to the display panel 40 to eliminate or reduce an extent of damage or a damaged area.

As shown in FIG. 2, in one of the embodiments, the display panel 40 is a liquid crystal display panel 40 provided with a gate driver on array (GOA) circuit 41, the temperature detection module 10 is configured to detect a temperature in an area related to the GOA circuit 41, and the current detection module 30 is configured to detect a real-time current value of the GOA circuit 41.

It can be understood that the current detection module 30 can choose to detect a current value of any one of electrical units, and meanwhile the temperature detection module 10 can choose to detect a corresponding temperature of the any one of electrical units. The detection of temperature or current belongs to a category that can be understood by those skilled in the art, and which will not be described herein. In this embodiment, the any one of electrical units may be, but is not limited to, the GOA circuit 41, and it may also be a data driver, a pixel circuit, clock signal lines, or start signal lines in the display panel 40.

Wherein, the GOA circuit 41 is disposed on at least one side of the display panel 40.

Wherein, the temperature detection module 10 can detect a surface temperature of a GOA circuit 41 area. In normal operation, the surface temperature of the GOA circuit 41 area is usually below 45° C. or 55° C., and a range from 45° C. to 55° C. belongs to a higher temperature range. In a design stage, a plurality of groups of temperature points are usually selected below 45° C., below 55° C., or from the range of 45° C. to 55° C. Electrical signals corresponding to the temperature points are recorded to obtain default current values corresponding to the electrical signals, and the default current values are stored in the electrical potential shifting module 20.

In one of the embodiments, the electrical potential shifting module 20 obtains the electrical signal at a fixed time interval to renew the default current value corresponding to the electrical signal.

It can be understood that in this embodiment, the electrical potential shifting module 20 obtains the electrical signal at the fixed time interval and renews the default current value corresponding to the electrical signal at the fixed time interval correspondingly, which can reduce frequencies of obtaining the electrical signal and renewing the default current value by the electrical potential shifting module 20, thereby reducing workload of the electrical potential shifting module 20 and is beneficial to achieving an accurate overcurrent protection function with a lower power consumption.

Wherein, the fixed time interval may be, but is not limited to, zero second or a time interval greater than zero, for example, the fixed time interval T=N*TF, wherein N is a natural number greater than zero, and TF is a time period for the display panel 40 to display one frame picture.

As shown in FIG. 2, in one of the embodiments, the temperature detection module 10 includes a voltage divider resistor R2 and a thermistor R1 configured to detect the temperature of the display panel 40. A first voltage signal VDD is connected to a first end of the thermistor R1, a second end of the thermistor R1 is connected to a first end of the voltage divider resistor R2, a connected node of the thermistor R1 and the voltage divider resistor R2 outputs the electrical signal, and a second end of the voltage divider resistor R2 is connected to a second voltage signal, wherein an electrical potential of the first voltage signal VDD is greater than an electrical potential of the second voltage signal.

It should be noted that in this embodiment, the electrical potential Vfb of the electrical signal has a formula of Vfb=VDD*R2/(R1+R2), wherein, VDD is the first voltage signal VDD, and at this time, an electrical potential of the second voltage signal is zero.

It can be understood that the first voltage signal VDD may be, but is not limited to, a direct electrical potential signal greater than zero, and the second voltage signal is a direct electrical potential signal not greater than zero or an electrical potential signal that is connected to a ground electrical potential or a zero electrical potential. The first voltage signal VDD and the second voltage signal can constitute a corresponding voltage difference to allow this embodiment to have normal operation.

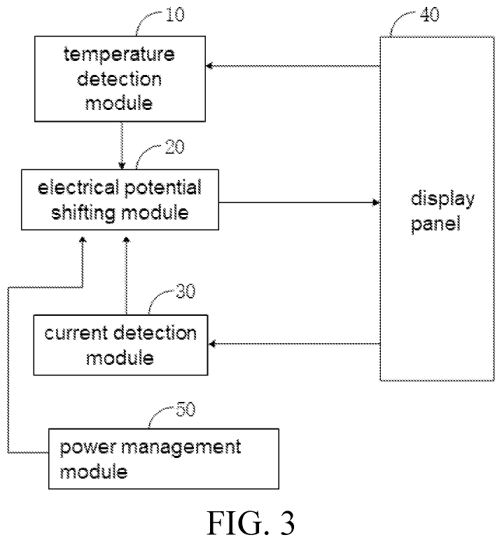

As shown in FIG. 3, in one of the embodiments, the display equipment further includes a power management module 50 connected to at least the electrical potential shifting module 20 to power the electrical potential shifting module 20.

It can be understood that the power management module 50 may provide the display equipment a corresponding power supply and has corresponding power management or a function to control the power management. A relationship between the power management module 50 and other parts in the display equipment does not affect normal implementation of the present disclosure and will not be described in detail herein.

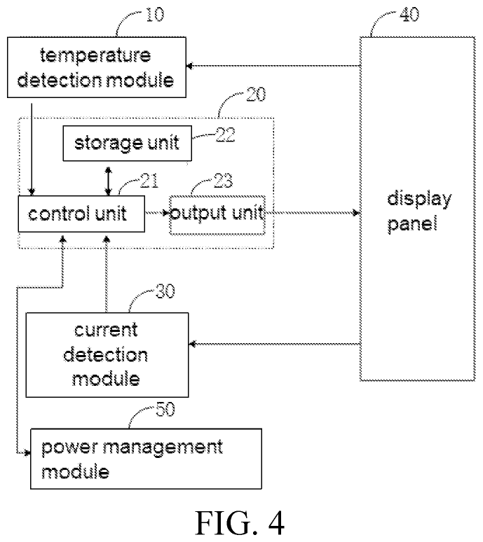

As shown in FIG. 4, in one of the embodiments, the electrical potential shifting module 20 includes a control unit 21, a storage unit 22, and an output unit 23. The power management module 50 is connected to at least the control unit 21, and the control unit 21 is connected to the temperature detection module 10, the current detection module 30, the storage unit 22, and the output unit 23. The control unit 21 calls the default current value in the storage unit 22 corresponding to the electrical signal to compare with the real-time current value, when the real-time current value is greater than or equal to the default current value, the control unit 21 outputs a control signal to the power management module 50, and the power management module 50 stops powering the electrical potential shifting module 20 according to the control signal.

It can be understood that the storage unit 22 stores a plurality of groups of default current values corresponding to one property of the electrical signal, that is, a correspondence of the electrical signal and the default current value may be, but is not limited to, one-to-one, and it may also be one-to-many, many-to-one, or a point value and a range value corresponding to each other.

Wherein, the power management module 50 can stop powering the electrical potential shifting module 20 according to a high electrical potential/low electrical potential of the control signal, thereby stopping the electrical potential shifting module 20 outputting or working.

In one of the embodiments, the thermistor R1 may be, but is not limited to, a thermistor R1 with a negative temperature coefficient, or may be a thermistor R1 with a positive temperature coefficient. Correspondingly, positions of the voltage divider resistor R2 and the thermistor R1 can be changed or not. Wherein, the voltage divider resistor R2 may be an adjustable resistor, which is convenient for pre-test and post-maintenance. For example, when electronic components aging or used for a time period, resistance values will be changed, which affects a scale factor between the temperature and the electrical signal, thereby reducing the accuracy of the overcurrent protection. At this time, the adjustable resistor can be used to readjust the scale factor between the temperature and the electrical signal without changing the voltage divider resistor R2 or the thermistor R1.

Wherein, it can be understood that the voltage divider resistor R2 and the thermistor R1 are semiconductor components and can be integrated into a corresponding film layer structure of the display panel 40, such as a film layer structure of the GOA circuit 41 area, which can omit an installation process and is convenient for accurately measuring the temperature.

In one of the embodiments, the electrical signal may be, but is not limited to, a voltage signal, and may also be a current signal.

In one of the embodiments, the electrical potential shifting module 20 stores a plurality of groups of default current values corresponding to the electrical potential Vfb of the electrical signal.

In one of the embodiments, the temperature may have a positive correlation with the electrical potential Vfb of the electrical signal, but is not limited to this.

In one of the embodiments, the electrical potential Vfb of the electrical signal may have a negative correlation with the default current value, but is not limited to this.

It can be understood that the positive correlation in corresponding embodiments may be that as the temperature rises, the electric potential Vfb or the current value of the electrical signal also increases. Further, the positive correlation can also be a proportional relationship. The negative correlation in the corresponding embodiments may be that as the electric potential Vfb or the current value of the electrical signal increases, the default current value reduces. Further, the negative correlation can also be an inverse proportional relationship.

In one of the embodiments, the present disclosure provides a display device which includes any one of the display equipments in the above embodiments.

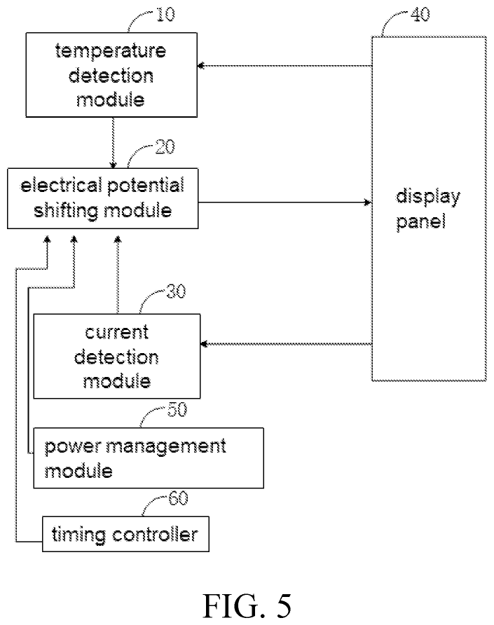

As shown in FIG. 5, in one of the embodiments, the display device further includes a timing controller 60 connected to at least the electrical potential shifting module 20. It can be understood that the timing controller 60 can provide the electrical potential shifting module 20 at least one of square wave signals such as a start signal and a clock signal.

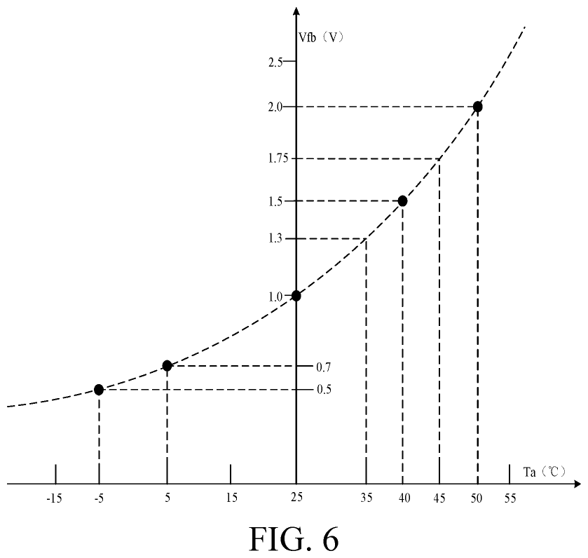

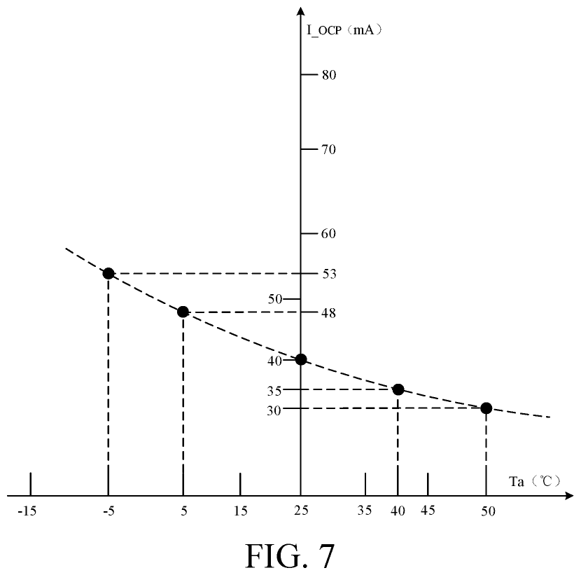

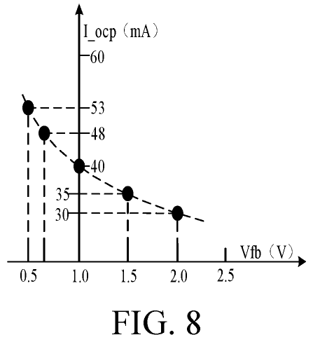

As shown in FIGS. 6 to 8, the thermistor R1 is the thermistor R1 with the negative temperature coefficient. When using the temperature detection module 10 shown in FIG. 2 to detect, the correspondences between the temperature Ta, the electrical potential Vfb of the electrical signal, and the default current value I_ocp satisfies data shown in Table 1-1.

TABLE 1-1

| Ta | Vfb | I_ocp |
|---|---|---|
| (° C.) | (V) | (mA) |
| −5 | 0.5 | 53 |
| 5 | 0.7 | 48 |
| 25 | 1 | 40 |
| 40 | 1.5 | 35 |
| 50 | 2 | 30 |

It can be understood that the corresponding data relationship given in Table 1-1 is only to corroborate the corresponding embodiments of the present disclosure and to further support the inventive advancement of the present disclosure, and should not as a means to limit the implementation of the present invention.

It can be understood that for a person of ordinary skill in the art, equivalent replacements or changes can be made according to the technical solution of the present disclosure and its inventive concept, and all these changes or replacements should fall within the protection scope of the claims attached to the present disclosure.

What is claimed is:

1. A display equipment, comprising:
a temperature detection module configured to detect a temperature of a display panel and to output an electrical signal corresponding to the temperature;
a current detection module configured to detect a real-time current value of the display panel; and
an electrical potential shifting module connected to the temperature detection module, the current detection module, and the display panel, and configured to receive the electrical signal and the real-time current value and to correspondingly output an electrical potential signal to the display panel according to a comparison result between the real-time current value and a default current value;
wherein the electrical potential shifting module is provided with the default current value corresponding to the electrical signal, when the real-time current value is greater than or equal to the default current value, the electrical potential shifting module stops outputting, and the electrical signal is a voltage signal.

2. The display equipment according to claim 1, wherein the display panel is a liquid crystal display panel provided with a gate driver on array (GOA) circuit, the temperature detection module is configured to detect a temperature in an area related to the GOA circuit, and the current detection module is configured to detect a real-time current value of the GOA circuit.

3. The display equipment according to claim 1, wherein the electrical potential shifting module obtains the electrical signal at a fixed time interval to renew the default current value corresponding to the electrical signal.

4. The display equipment according to claim 1, wherein the temperature detection module comprises a voltage divider resistor and a thermistor configured to detect the temperature of the display panel, a first voltage signal is connected to a first end of the thermistor, a second end of the thermistor is connected to a first end of the voltage divider resistor, a connected node of the thermistor and the voltage divider resistor outputs the electrical signal, and a second end of the voltage divider resistor is connected to a second voltage signal, wherein an electrical potential of the first voltage signal is greater than an electrical potential of the second voltage signal.

5. The display equipment according to claim 1, further comprising a power management module connected to at least the electrical potential shifting module to power the electrical potential shifting module.

6. The display equipment according to claim 5, wherein the electrical potential shifting module comprises a control unit, a storage unit, and an output unit;
the power management module is connected to at least the control unit, and the control unit is connected to the temperature detection module, the current detection module, the storage unit, and the output unit; and
the control unit calls the default current value in the storage unit corresponding to the electrical signal to compare with the real-time current value, when the real-time current value is greater than or equal to the default current value, the control unit outputs a control signal to the power management module, and the power management module stops powering the electrical potential shifting module according to the control signal.

7. The display equipment according to claim 4, wherein the thermistor is a thermistor with a negative temperature coefficient.

8. The display equipment according to claim 1, wherein the electrical potential shifting module stores a plurality of groups of default current values each corresponding to an electrical potential of the electrical signal.

9. A display equipment, comprising:
a temperature detection module configured to detect a temperature of a display panel and to output an electrical signal corresponding to the temperature;
a current detection module configured to detect a real-time current value of the display panel; and
an electrical potential shifting module connected to the temperature detection module, the current detection module, and the display panel, and configured to receive the electrical signal and the real-time current value and to correspondingly output an electrical potential signal to the display panel according to a comparison result between the real-time current value and a default current value;
wherein the electrical potential shifting module is provided with the default current value corresponding to the electrical signal, when the real-time current value is greater than or equal to the default current value, the electrical potential shifting module stops outputting.

10. The display equipment according to claim 9, wherein the display panel is a liquid crystal display panel provided with a gate driver on array (GOA) circuit, the temperature detection module is configured to detect a temperature in an area related to the GOA circuit, and the current detection module is configured to detect a real-time current value of the GOA circuit.

11. The display equipment according to claim 10, wherein the electrical potential shifting module obtains the electrical signal at a fixed time interval to renew the default current value corresponding to the electrical signal.

12. The display equipment according to claim 11, wherein the temperature detection module comprises a voltage divider resistor and a thermistor configured to detect the temperature of the display panel, a first voltage signal is connected to a first end of the thermistor, a second end of the thermistor is connected to a first end of the voltage divider resistor, a connected node of the thermistor and the voltage divider resistor outputs the electrical signal, and a second end of the voltage divider resistor is connected to a second voltage signal, wherein an electrical potential of the first voltage signal is greater than an electrical potential of the second voltage signal.

13. The display equipment according to claim 9, further comprising a power management module connected to at least the electrical potential shifting module to power the electrical potential shifting module.

14. The display equipment according to claim 13, wherein the electrical potential shifting module comprises a control unit, a storage unit, and an output unit;
the power management module is connected to at least the control unit, and the control unit is connected to the temperature detection module, the current detection module, the storage unit, and the output unit; and
the control unit calls the default current value in the storage unit corresponding to the electrical signal to compare with the real-time current value, when the real-time current value is greater than or equal to the default current value, the control unit outputs a control signal to the power management module, and the power management module stops powering the electrical potential shifting module according to the control signal.

15. The display equipment according to claim 12, wherein the thermistor is a thermistor with a negative temperature coefficient.

16. The display equipment according to claim 9, wherein the electrical potential shifting module stores a plurality of groups of default current values each corresponding to an electrical potential of the electrical signal.

17. The display equipment according to claim 9, wherein the temperature has a positive correlation with an electrical potential of the electrical signal.

18. The display equipment according to claim 9, wherein an electrical potential of the electrical signal has a negative correlation with the default current value.

19. A display device comprising the display equipment according to claim 1.

20. The display device according to claim 19, further comprising a timing controller connected to at least the electrical potential shifting module.
